(19) United States
(12) Patent Application Publication
(10) Pub. No.: US 2009/0237444 A1
(43) Pub. Date: Sep. 24, 2009

(54) LIQUID EJECTING APPARATUS AND METHOD OF CLEANING LIQUID EJECTING HEAD

(75) Inventors: Nagatoshi KASAHARA, Matsumoto-shi (JP); Toshihiro SHINBARA, Matsumoto-shi (JP); Ryoichi TANAKA, Shiojiri-shi (JP); Teruaki KAIEDA, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/405,388

(22) Filed: Mar. 17, 2009

(30) Foreign Application Priority Data
Mar. 18, 2008 (JP) 2008-069564

(51) Int. Cl. B41J 2/165

(52) U.S. Cl. 347/27; 347/30

(57) ABSTRACT

A liquid ejecting apparatus includes: a plurality of nozzle openings that eject liquid; pressure generating chambers in communication with the respective nozzle openings; a liquid ejecting head including a pressure generating unit that causes the pressure generating chambers to generate a pressure change; a sucking unit that covers the nozzle openings and sucks the liquid from the nozzle openings; a suction control unit that causes the sucking unit to suck the liquid from the nozzle openings; and a liquid flow control unit that brings the pressure generating units into vibrations selectively corresponding to the pressure generating chambers to vibrate when sucking the liquid by the sucking unit and controls a flow of fluid in the pressure generating chambers by not driving the pressure generating units corresponding to the non-selected pressure generating chambers.

### BACKGROUND

1. Technical Field

The present invention relates to a liquid ejecting apparatus having a liquid ejecting head that ejects liquid from nozzle openings and a method of cleaning the liquid ejecting head.

2. Related Art

An ink jet printing apparatus such as an ink jet printer or a plotter includes an ink jet printhead which is able to discharge ink stored in an ink storage unit such as an ink cartridge and an ink tank as ink drops.

The ink jet printhead here includes pressure generating chambers which are in communication with nozzle openings and a pressure generating unit that causes a pressure change in the pressure generating chambers to cause liquid drops to be discharged from the nozzle openings. As the pressure generating unit to be mounted on the ink jet printhead includes, for example, a vertically vibrating piezoelectric element, a flexibly vibrating piezoelectric element, and the one using electrostatic force.

In the ink jet printheads as described above, air bubbles entered when replacing the ink cartridge or those contained in the ink may stay in the pressure generating chambers, so that a print failure such as “dot missing” might occur. Therefore, the ink jet printing apparatus includes a suction cap which is connected to a suction pump that sucks ink in the vicinity of the nozzle openings.

The suction cap prevents the print failure such as the dot missing by filling the pressure generating chambers with ink by being capped on an end surface of the ink jet printhead and performing a sucking action which sucks the ink in the vicinity of the nozzle openings.

However, when the sucking action that sucks the ink from all the nozzle openings is carried out, the ink is also sucked out from the pressure generating chambers in an normal state which are filled the ink, the amount of ink consumption is disadvantageously increased.

Therefore, an ink jet printing apparatus configured to specify a nozzle block such as a nozzle row which includes a plurality of nozzle openings having the pressure generating chambers in which an ink filling failure occurs, and performing the sucking action only for such the nozzle block is proposed (for example, see JP-A-2005-53047 and JP-A-2005-262821).

Alternatively, there is proposed a configuration in which the piezoelectric elements are brought into micro-vibrations during the sucking action, so that the air bubble dischargeability property is improved (for example, see JP-A-11-78067).

However, according to JP-A-2005-53047 and JP-A-2005-262821, since the sucking action is performed for the nozzle block, even when the pressure generating chambers filled normally with ink exist in the nozzle block, the ink is sucked from the normal pressure generating chamber. Therefore, there remains the problem of increase in amount of ink consumption.

Also, in order to perform the sucking action for the nozzle blocks selectively as in JP-A-2005-53047 and JP-A-2005-262821, there arise problems such that the apparatus is upsized, and the cost is increased.

Also, in JP-A-2005-262821, a method of performing the sucking action for the nozzle block and a flushing action by driving the piezoelectric element to cause the ink to be discharged selectively according to the number of the nozzle openings at which the dot missing occurs in the nozzle block, to cause only the nozzle openings at which the dot missing occurs to perform the flushing action when performing the flushing action, and to bring the nozzle openings at which the dot missing does not occur into micro vibrations is disclosed. However, the method in JP-A-2005-262821 simply performs the sucking action and the flushing action step by step according to the number of the nozzle openings having the dot missing, and brings the nozzle openings at which the dot missing does not occur into micro vibrations simultaneously with the flushing action in order to prevent increase in viscosity. In other words, the method in JP-A-2005-262821 simply causes the sucking action, the flushing action, and the micro vibration to be performed step by step, and when the flushing action is performed only for the nozzle openings at which the dot missing occurs and the micro vibrations are generated at the nozzle openings at which the dot missing does not occur, vibrations occurs in the respective pressure generating chambers, a flow of the ink from the pressure generating chambers filled normally filled with ink to the pressure generating chambers insufficiently filled with ink does not occur, so that the amount of ink consumption in the sucking action cannot be reduced.

In JP-A-11-78067, the air bubble dischargeability is improved by bringing the piezoelectric elements into micro vibrations during the sucking action, but the amount of ink consumption cannot be reduced.

Such problems exist not only in the ink jet printing apparatus, but also in the liquid ejecting apparatus which ejects liquid other than ink.

### SUMMARY OF THE INVENTION

An advantage of some aspects of the invention is to provide a liquid ejecting apparatus in which the amount of liquid consumption is reduced and hence the cost is reduced without upsizing the apparatus, and a method of cleaning the liquid ejecting head.

According to a first aspect of the invention, there is provided a liquid ejecting apparatus including: a plurality of nozzle openings that eject liquid; pressure generating chambers in communication with the respective nozzle openings; a liquid ejecting head including a pressure generating unit that causes the pressure generating chambers to generate a pressure change; a sucking unit that covers the nozzle openings and sucks the liquid from the nozzle openings; a suction control unit that causes the sucking unit to suck the liquid from the nozzle openings; and a liquid flow control unit that brings the pressure generating units into vibrations selectively corresponding to the pressure generating chambers to vibrate when sucking the liquid by the sucking unit and controls a flow of fluid in the pressure generating chambers by not driving the pressure generating units corresponding to the non-selected pressure generating chambers.

In this configuration, the flowability of the liquid on the side of the non-selected desired pressure generating chambers is enhanced by restraining the flowability of the liquid in the selected pressure generating chambers, so that efficient suction of the liquid in the non-selected pressure generating chambers is achieved by the sucking unit. Accordingly, the liquid dischargeability from the nozzle openings which communicate with the desired pressure generating chambers is improved, so that a sucking action is achieved in a short time by a small number of times, whereby the amount of liquid consumption is reduced. In addition, since the amount of liquid consumption is reduced without upsizing the apparatus, the cost is decreased.

Preferably, the vibrations that the liquid flow control unit causes the selected pressure generating unit to perform is micro vibrations. In this configuration, since the action to press the liquid out from the nozzle openings by driving pulses is prevented by supplying micro vibration pulses to bring the selected pressure generating unit into micro vibrations, unnecessary exhaust of the liquid by the driving pulses is minimized.

Preferably, a detecting unit that detects a liquid filling state in the pressure generating chambers is further provided, and the liquid flow control unit brings the pressure generating unit corresponding to the pressure generating chambers normally filled with the liquid into vibrations on the basis of the result of detection of the detecting unit. Accordingly, air bubbles are efficiently discharged together with the liquid from the pressure generating chambers having a filling failure and including the air bubbles staying therein.

Preferably, the sucking unit includes a cap member that covers the nozzle openings and a sucking device that is connected to the cap member and sucks the interior of the cap member. Accordingly, the interior of the flow channel of the pressure generating chamber or the like is cleaned by sucking the liquid from the nozzle openings by the cap member.

Preferably, the liquid flow control unit applies vibration pulses having high frequencies in comparison with discharge driving pulses for discharging liquid to the pressure generating unit to cause vibrations. Accordingly, the possibility that the liquid is supplied to the selected pressure generating chambers by the vibrations by the vibration pulses having the high frequencies in comparison with the discharge driving pulses is reduced, so that enhancement of the liquid flowability on the side of the non-selected desired pressure generating chambers is ensured.

According to a second aspect of the invention, there is provided a method of cleaning a liquid ejecting head that performs a sucking action for sucking liquid from a plurality of nozzle openings of the liquid ejecting head having the plurality of nozzle openings that ejects the liquid, pressure generating chambers in communication with the respective nozzle openings; and a pressure generating unit that causes a pressure change in the pressure generating chambers, including: controlling a flow of the liquid in the pressure generating chambers by selectively bringing the pressure generating units corresponding to the pressure generating chambers into vibrations and sucking the liquid from the nozzle openings without bringing the pressure generating units corresponding to the non-selected pressure generating chambers into vibrations.

In this configuration, the flowability of the liquid on the side of the non-selected desired pressure generating chambers is enhanced by restraining the flowability of the liquid in the selected pressure generating chambers, so that efficient suction of the liquid in the non-selected pressure generating chambers is achieved. Accordingly, the liquid dischargeability from the nozzle openings which communicate with the desired pressure generating chambers is improved, so that the sucking action is achieved in a short time by a small number of times, whereby the amount of liquid consumption is reduced. In addition, since the amount of liquid consumption is reduced without upsizing the apparatus, the cost is decreased.

### BRIEF DESCRIPTION OF THE DRAWINGS

The invention will be described with reference to the accompanying drawings where like numbers reference like elements.

FIG. 1 is a schematic perspective view of a printing apparatus according to a first embodiment of the invention.

FIG. 2 is a cross-sectional view of a printhead according to the first embodiment of the invention.

FIG. 3 is a schematic perspective view showing the printhead and a sucking unit according to the first embodiment of the invention.

FIG. 4 is a cross-sectional view of the printhead and the sucking unit according to the first embodiment of the invention.

FIG. 5 is a block diagram showing a control configuration of the printing apparatus according to the first embodiment of the invention.

FIG. 6 is a schematic cross-sectional view showing a sucking action according to the first embodiment of the invention,

FIG. 7 is a schematic plan view showing the sucking action according to the first embodiment of the invention.

### DESCRIPTION OF EXEMPLARY EMBODIMENTS

The invention will be described in detail on the basis of embodiments.

### First Embodiment

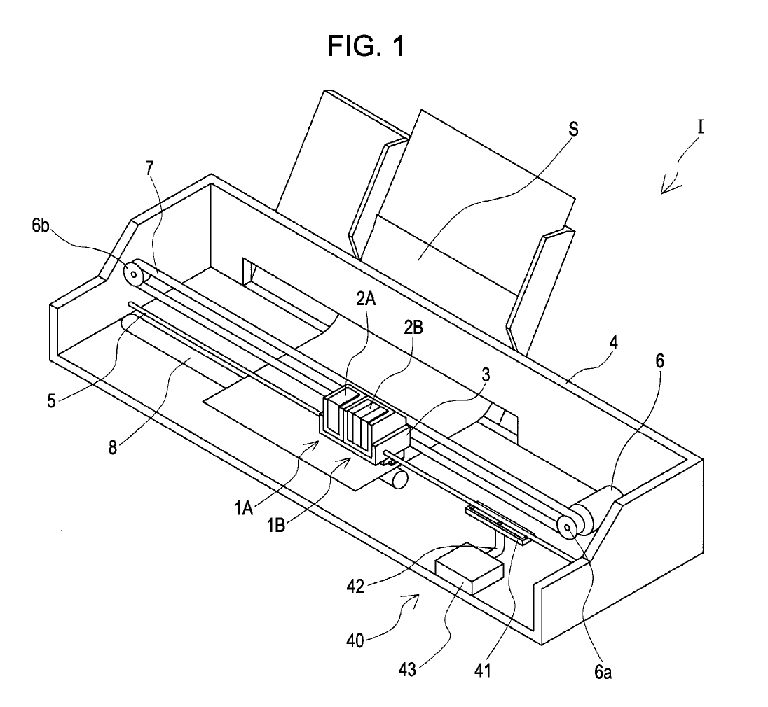

FIG. 1 is a schematic perspective view of an ink jet printing apparatus as an example of a liquid ejecting apparatus according to a first embodiment of the invention.

A liquid ejecting apparatus according to the first embodiment is, for example, an ink jet printing apparatus and, as shown in FIG. 1, printhead units 1A and 1B having the ink jet printhead, descried later in detail, each include ink cartridges 2A and 2B which constitute ink supply units demountably mounted thereon, and a carriage 3 having the printhead units 1A and 1B mounted thereon are provided on a carriage shaft 5 attached to an apparatus body 4 so as to be capable of moving in the axial direction. The printhead units 1A and 1B are configured to discharge black ink composition and color ink compositions, respectively.

A drive motor 6 is provided near one end of the carriage shaft 5, and a first pulley 6a having a groove on the outer periphery thereof is provided at the distal end of the shaft of the drive motor 6. A second pulley 6b corresponding to the first pulley 6a of the drive motor 6 is rotatably provided near the other end of the carriage shaft 5, and a timing belt 7 formed of an annular resilient member such as rubber is provided between the first pulley 6a and the second pulley 6b.

Then, by a drive force from the drive motor 6 transmitted to the carriage 3 via the timing belt 7, the carriage 3 having the printhead units 1A and 1B mounted thereon is moved along the carriage shaft 5. On the other hand, a platen 8 is provided on the apparatus body 4 along the carriage 3. This platen 8 is configured to be able to rotate by a drive force of a paper feed motor, not shown, and a printing sheet S as a printing medium such as paper supplied by a paper feed roller or the like, not shown, is wound around the platen 8 and is transported.

Provided in a non-printing area on the side of the platen 8, which is the end in the direction of movement of the carriage 3 is a sucking unit 40 which performs a sucking action by sucking ink from nozzle openings of the ink jet printhead described later.

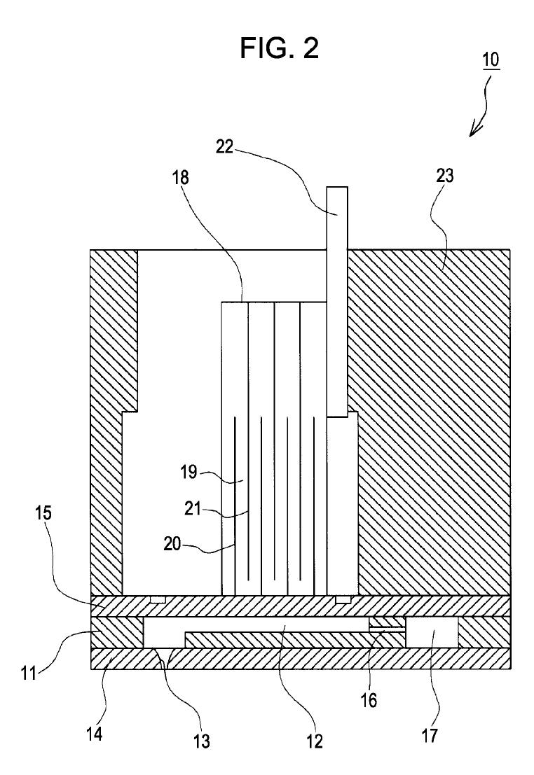

The ink jet printhead to be mounted on the ink jet printing apparatus as described above will be described. FIG. 2 is a cross-sectional view showing an example of the ink jet printhead according to the first embodiment of the invention.

An ink jet printhead 10 shown in FIG. 2 is of a type having a vertically vibrating piezoelectric element, and a spacer 11 includes a plurality of pressure generating chambers 12 arranged in parallel with each other, and both ends of the spacer 11 are sealed by a nozzle plate 14 having nozzle openings 13 corresponding to the respective pressure generating chambers 12 and a diaphragm 15. The spacer 11 is formed with a reservoir 17 as a common ink chamber of the plurality of pressure generating chambers 12 by being communicated with the respective pressure generating chambers 12 via ink supply ports 16 respectively, and an ink cartridge, not shown, is connected to the reservoir 17.

In contrast, distal ends of piezoelectric elements 18 are in contact with the diaphragm 15 on the opposite side from the pressure generating chambers 12 in areas corresponding to the respective pressure generating chambers 12. The piezoelectric elements 18 is formed by laminating a piezoelectric material 19, and electrode forming materials 20 and 21 alternately in a vertical sandwich-like pattern, and an inactive area which does not contribute to vibrations is secured to a fixed substrate 22. The fixed substrate 22, the diaphragm 15, the spacer 11, and the nozzle plate 14 are integrally fixed via the base 23.

In the ink jet printhead 10 configured as descried above, ink is supplied to the reservoir 17 via an ink flow channel communicated to the ink cartridge, and is distributed to the respective pressure generating chambers 12 via the ink supply ports 16. Actually, the piezoelectric elements 18 are contracted by applying a voltage to the piezoelectric elements 18. Accordingly, the diaphragm 15 is deformed (pulled upward in the drawing) together with the piezoelectric elements 18 and hence the capacities of the pressure generating chambers 12 are increased, whereby ink is drawn into the pressure generating chambers 12. Then, by releasing a voltage applied to the electrode forming materials 20 and 21 of the piezoelectric elements 18 according to record signals from a drive circuit after having filled the interior with ink up to the nozzle openings 13, the piezoelectric elements 18 is elongated, and is restored to the original state. Accordingly, since the diaphragm 15 is displaced as well and is restored to the original state, the pressure generating chambers 12 is compressed, and the interior pressure is increased, so that ink drops are discharged from the nozzle openings 13. In other words, in the first embodiment, vertically vibrating piezoelectric elements 18 are provided as pressure generating units for causing the pressure change in the pressure generating chambers 12.

In the ink jet printhead 10 as described above, air bubbles entering when the cartridges 2A and 2B are mounted initially or replaced or air bubbles contained in the ink during a printing operation stays in the pressure generating chambers 12 and the air bubbles absorb the pressure variations in the pressure generating chambers 12, so that the discharge of the ink drops cannot be performed normally, and a print failure such as the dot missing might occur. Therefore, in the non-printing area of the ink jet printing apparatus, there is provided the sucking unit 40 that sucks the air bubbles together with ink from the flow channels of the pressure generating chambers 12 or the like via the nozzle openings 13.

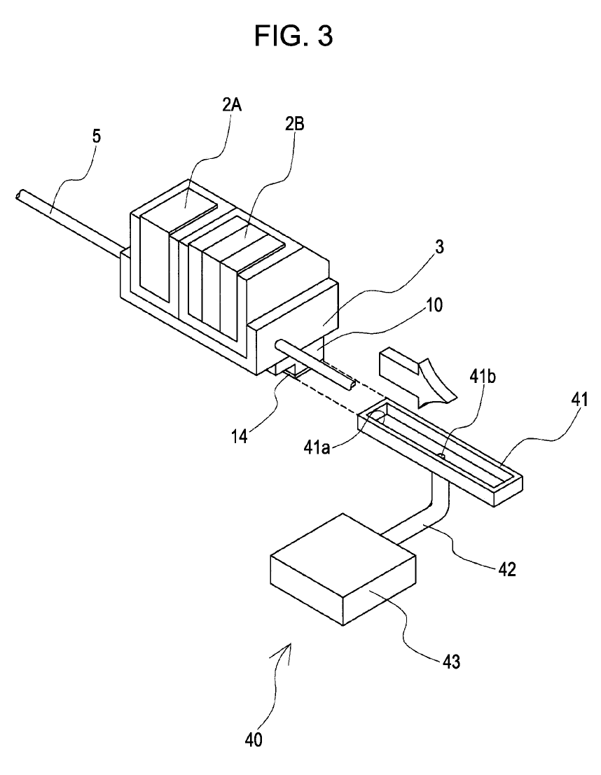

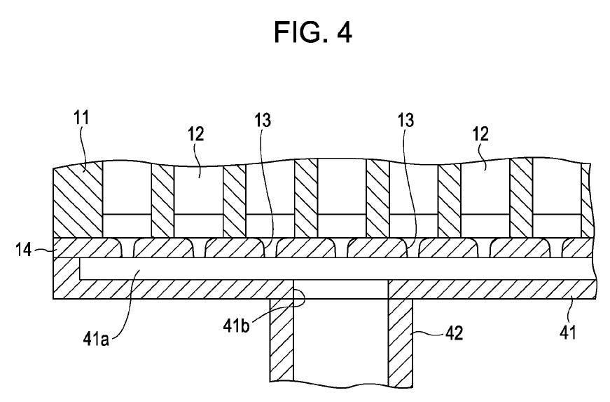

The sucking unit 40 will be described in detail now. FIG. 3 is a schematic perspective view showing the ink jet printhead and the sucking unit, and FIG. 4 is a cross-sectional view of the ink jet printhead and the sucking unit.

As shown in FIG. 3, the sucking unit 40 includes a cap member 41 that covers the nozzle openings of the ink jet printhead 10 and a sucking device 43 such as a vacuum pump connected to the cap member 41 via a tube 42.

The cap member 41 is provided so as to oppose the nozzle plate 14 of the ink jet printhead 10, and is provided so as to cover all the plurality of nozzle openings 13.

The cap member 41 includes a suction port 41a that opposes the nozzle plate 14 and opens over the entire nozzle openings 13 as shown in FIG. 4. The cap member 41 covers all the nozzle openings 13 by the edge portion of the suction port 41a coming into contact with a surface of the nozzle plate 14. The cap member 41 includes a communication port 41b on the surface thereof opposite from the suction port 41a so as to communicate with the suction port 41a, and the sucking device 43 is connected to the communication port 41b via the tube 42.

The sucking unit 40 configured as described above brings the edge portion of the suction port 41a of the cap member 41 into contact with the surface of the nozzle plate 14 and causes the sucking device 43 to perform the sucking action to bring the interior of the cap member 41 into a negative pressure and suck the ink in the flow channels such as the pressure generating chambers 12 from the nozzle openings 13 together with the air bubbles. The cap member 41 has a role to cover the nozzle openings 13 at a timing other than the sucking action, such as when the power is turned off, at the waiting time, at regular timings, or the like and prevent ink near the nozzle openings 13 from increase in viscosity due to drying of the ink.

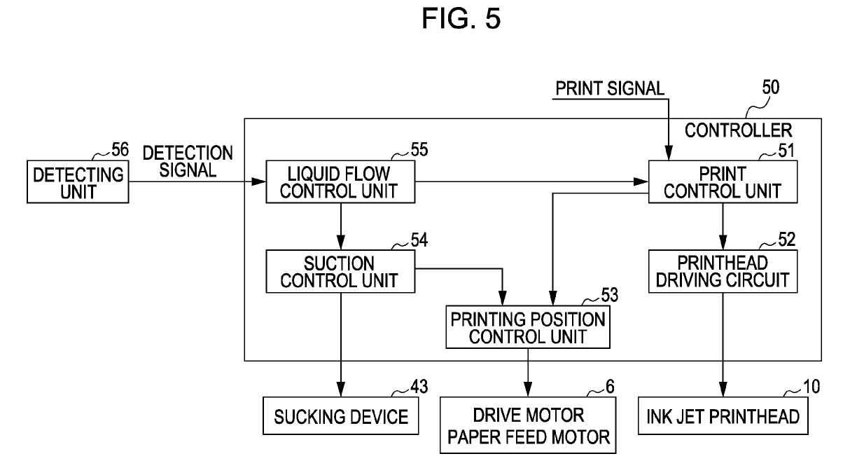

A control configuration for controlling the ink jet printhead as described above will be described now. FIG. 5 is a block diagram showing the control configuration of the ink jet printhead.

As shown in FIG. 5, an ink jet printing apparatus I includes the ink jet printhead 10 which corresponds to a mechanism portion which actually performs a printing job, the sucking unit 40 that sucks the ink from the nozzle openings 13 of the ink jet printhead 10, and a controller 50 that controls actions of the ink jet printhead 10 and the sucking unit 40.

The controller 50 includes a print control unit 51, a printhead driving circuit 52, a printing position control unit 53, a suction control unit 54, and a liquid flow control unit 55.

The print control unit 51 controls the printing operation of the ink jet printhead 10 and, for example, applies driving pulses to the piezoelectric elements 18 via the printhead driving circuit 52 in association with the input of a print signal, and causes the ink jet printhead 10 to discharge ink.

The printing position control unit 53 determines the position of the ink jet printhead 10 at the time of printing and at the time of being capped in a primary scanning direction and a secondary scanning direction. More specifically, the printing position control unit 53 drives the drive motor 6 and moves the carriage 3 in the primary scanning direction to position the ink jet printhead 10 in the primary scanning direction, then drives the paper feed motor, not shown, to rotate the platen 8 and move the printing sheet S in the secondary scanning direction, thereby positioning the ink jet printhead 10 in the secondary direction with respect to the printing sheet S. Then, the printing position control unit 53 moves the carriage 3 on which the ink jet printhead 10 is mounted in the primary scanning direction when printing, and moves the printing sheet S in the secondary scanning direction. At the time of the sucking action, the printing position control unit 53 moves the carriage 3 on which the ink jet printhead 10 is mounted toward the sucking unit 40 provided in the non-printing area.

In the first embodiment, the ink jet printing apparatus I further includes a detector 56. The detector 56 detects an ink filling state in the respective pressure generating chambers 12 of the ink jet printhead 10. In the first embodiment, the detector 56 is configured to detect the ink filling state in the pressure generating chambers 12 by detecting the dot missing. More specifically, the detector 56 is, for example, an optical sensor or the like such as a scanner which causes the ink jet printing apparatus I to print a test pattern reads the printed pattern as an image, and detects the dot missing. The detector 56 is not specifically limited to this type, and may be configured to detect directly the ink filling state in the pressure generating chambers 12, and those known in the related art may be employed.

The suction control unit 54 controls the sucking action of the sucking unit 40. In other words, the suction control unit 54 activates the sucking device 43 of the sucking unit 40 at a predetermined timing, and causes the sucking unit 40 to perform the sucking action for sucking the ink in the vicinity of the nozzle openings 13 of the ink jet printhead 10. Specifically, the suction control unit 54 moves the ink jet printhead 10 to a position opposing the cap member 41 via the printing position control unit 53, caps the ink jet printhead 10 with the cap member 41, and drives the sucking device 43, thereby causing the sucking action.

The liquid flow control unit 55 controls the suction control unit 54 at a predetermined timing, causes the sucking unit 40 to perform the sucking action for sucking the ink in the vicinity of the nozzle openings 13 of the ink jet printhead 10, and controls the print control unit 51 on the basis of the ink filing state in the pressure generating chambers 12 detected by the detector 56, thereby bringing selectively the piezoelectric elements 18 corresponding to the pressure generating chambers 12 which is normally filled with ink into micro vibrations

In other words, the liquid flow control unit 55 controls the suction control unit 54 to cause the sucking unit 40 to perform the sucking action while bringing the piezoelectric elements 18 corresponding to the nozzle openings 13 other than the nozzle openings 13 having the dot missing detected by the detector 56, that is, the nozzle openings 13 from which the ink drops are normally discharged into micro vibrations. In this manner, in the first embodiment, the liquid flow control unit 55 selects the nozzle openings 13 from which the ink drops are normally discharged, that is, the pressure generating chambers 12 filled with ink normally, and brings the piezoelectric elements 18 corresponding to the selected pressure generating chambers 12 into micro vibrations as the vibrations. Then, the liquid flow control unit 55 determines the piezoelectric elements 18 corresponding to the pressure generating chambers 12 which are in communication with the nozzle openings 13 where the dot missing occurs (the pressure generating chambers 12 having the ink filling failure) as unselect elements, and does not drive the corresponding piezoelectric elements 18.

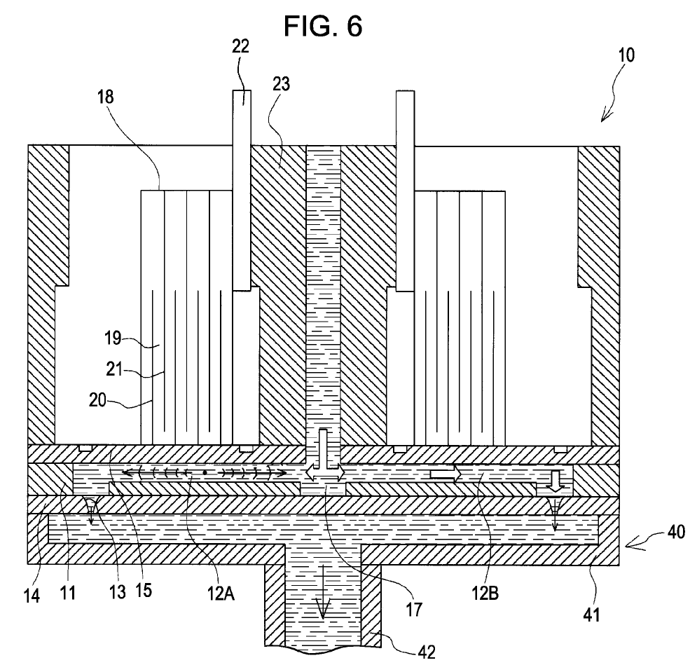

When pressure waves are generated in the pressure generating chambers 12 filled with ink normally by the micro vibrations, as shown in FIG. 6, the pressure wave of pressure generating chambers 12A filled with ink normally and flows of ink from the reservoir 17 to the pressure generating chambers 12A by suction cancel each other, so that the flow of ink sucked from the nozzle openings 13 in communication with the pressure generating chambers 12A filled with ink normally is weakened. In contrast, on the side of pressure generating chambers 12B having the ink filling failure, that is, having air bubbles staying therein, the flow of ink from the reservoir 17 to the pressure generating chambers 12B is increased by an amount corresponding to the amount of weakening of the flow of the ink on the side of the pressure generating chambers 12A which is filled with ink normally, so that the flows of the ink sucked from the nozzle openings 13 are amplified.

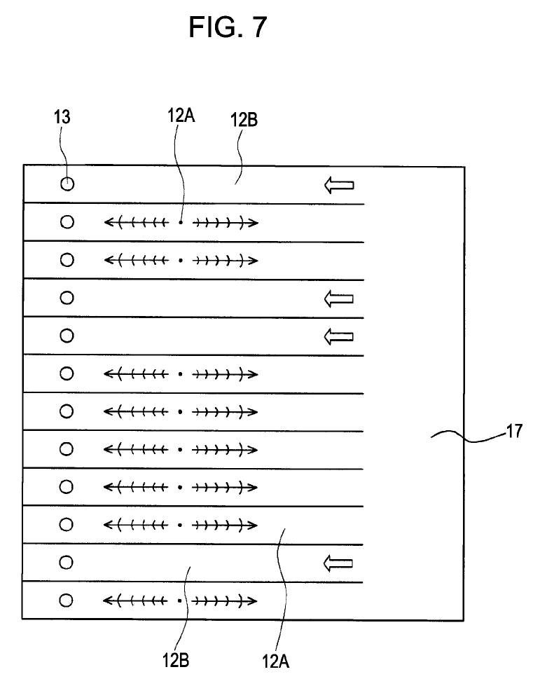

Therefore, the sucking action achieves improvement of the air bubble dischargeability from the pressure generating chambers 12 having the air bubbles staying therein and having the filling failure from the nozzle openings 13. Since the air bubble dischargeability is improved, the sucking action is achieved in a short time (smaller number of times of sucking) in comparison with a case in which the micro vibrations are not generated, so that reduction of the amount of ink consumption is achieved. In particular, as shown in FIG. 7, when the number of the nozzle openings 13 where the dot missing occurs, that is, the number of the pressure generating chambers 12B having the ink filling failure due to the air bubbles staying therein is small, the amount of ink discharged from many of the pressure generating chambers 12A filled normally with ink is reduced and, correspondingly, the efficient ink discharge from the side of the pressure generating chambers 12B having the ink filling failure is achieved. In other words, the liquid flow control unit 55 restrains the flowability of liquid in the selected pressure generating chambers 12, and enhances the flowability of ink in the non-selected desired pressure generating chambers 12 and, consequently, efficient suction of ink in the pressure generating chambers 12 which are not selected by the sucking unit 40 is achieved.

The micro vibrations that the liquid flow control unit 55 causes the piezoelectric elements 18 to generate is the driving pulses to an extent which does not cause ink to be discharged, and the cycle may be selected adequately according to the viscosity of the ink or the structure of the ink jet printhead 10 or the like. In the first embodiment, micro vibration driving pulses having square waves at relatively high frequencies are applied to the piezoelectric elements 18. Such the micro vibration driving pulses are set to have high-frequency waves in comparison with discharge driving pulses for causing the piezoelectric elements 18 to discharge ink, so that the supply of the ink from the reservoir 17 to the pressure generating chambers 12 corresponding to the piezoelectric elements 18 which are brought into micro vibrations is weakened and the flow of ink toward the pressure generating chambers 12 having the ink filling failure is amplified. In the first embodiment, the piezoelectric elements 18 is selectively brought into micro vibrations during the sucking action, so that an action of ink to be pushed out from the nozzle openings 13 which are in communication with the pressure generating chambers 12 filled with ink normally is minimized, and the discharge of ink from the normal nozzle openings 13 is restrained. In other words, it is because the probability that liquid is pushed out also from the nozzle openings 13 from which the ink drops are discharged normally as well is high if the piezoelectric elements 18 corresponding to the normal pressure generating chambers 12 are driven during the sucking action using the normal discharge driving pulses. As a matter of course, driving the piezoelectric elements 18 during the sucking action is not limited to the micro vibrations (micro vibration driving pulses), and other driving pulses (including the discharge driving pulses) may be used.

When the liquid flow control unit 55 controls the suction control unit 54 to cause the sucking device 43 to perform the sucking action, the sucking action may be performed at a predetermined pulses, or continuously for a certain time period. The micro vibrations of the piezoelectric elements 18 may be generated so as to match the pulses of the sucking action, or may be performed constantly during the sucking action irrespective of the pulses of the sucking action.

The sucking action that the liquid flow control unit 55 causes to perform by controlling the suction control unit 54 is performed at a predetermined timing such as the time of replacement of the ink cartridges 2A and 2B, at the time of waiting, before the printing job, or during the printing job as described above. Therefore, although not shown specifically, by providing a timer unit or the like for measuring time, the sucking action may be performed adequately according to the result of measurement of the timer unit.

### Another Embodiment

Although the embodiment of the invention has been descried thus far, the basic configuration of the invention is not limited to the configuration described above. For example, in the first embodiment described above, the detecting unit 56 that detects the ink filling state in the pressure generating chambers 12 is provided, and the liquid flow control unit brings the piezoelectric elements 18 corresponding to the pressure generating chambers 12 normally filled with ink into micro vibrations on the basis of the result of detection of the detecting unit 56. However, the invention is not specifically limited thereto and, for example, it is also possible, for example, not to provide the detecting unit 56 and to provide a plurality of nozzle opening groups including a plurality of nozzle openings 13 to achieve the sucking action while bringing the pressure generating chambers 12 corresponding to the respective nozzle opening groups into micro vibrations in sequence.

Although the liquid flow control unit 55 is provided separately from the print control unit 51 in the first embodiment described above, since the liquid flow control unit 55 simply brings the selected piezoelectric elements 18 into vibrations, the print control unit 51 may be adapted to also serve as the liquid flow control unit 55. It is also possible to cause the liquid flow control unit 55 to control the sucking unit 40, that is, to cause the liquid flow control unit 55 to also serve as the suction control unit 54.

Also, the vertically vibrating piezoelectric elements 18 which is formed by laminating the piezoelectric material 19 and the electrode forming materials 20 and 21 alternately for the expansion and contraction in the vertical direction is exemplified as the pressure generating unit which causes the pressure change in the pressure generating chambers 12 in the first embodiment described above. However, the invention is not specifically limited thereto and, for example, a thin-film type piezoelectric element formed by laminating the respective layers by film formation and lithography method or a thick-film type piezoelectric element formed by bonding green sheets or the like may be employed as the flexibly vibrating piezoelectric element formed by sandwiching a piezoelectric element layer formed of crystallized piezoelectric material by two electrodes of a lower electrode and an upper electrode. Also, as the pressure generating unit, so-called an electrostatic actuator or the like which generates a static electricity between the diaphragm and the electrode and causes the liquid drops to be discharged from the nozzle openings by deforming the diaphragm by the static electricity may also be used.

As the ink jet printing apparatus I descried above, the one in which the ink jet printhead 10 (the printhead units 1A and 1B) is mounted on the carriage 3 and moves in the primary scanning direction is exemplified. However, the invention is not limited thereto and, for example, the invention may also be applied to a so-called line type printing apparatus in which the ink jet printhead 10 is fixed and performs the printing job only by moving the printing sheet S such as paper in the secondary scanning direction.

The invention is intended to be applied widely to general liquid ejecting heads and, for example, the invention may be applied to printhead such as various ink jet printheads used in an image printing apparatus such as printers, a color material ejecting head used for manufacturing color filters of liquid crystal displays or the like, electrode material ejecting heads used for forming electrodes such as organic ED displays, FEDs (field emission displays) or the like, or biological organic substances ejecting heads used for manufacturing bio chips. The liquid ejecting apparatus having such the liquid ejecting head mounted thereon is not specifically limited as a matter of course.

What is claimed is:

1. A liquid ejecting apparatus comprising:
a plurality of nozzle openings that eject liquid;
pressure generating chambers in communication with the respective nozzle openings;
a liquid ejecting head including a pressure generating unit that causes the pressure generating chambers to generate a pressure change;
a sucking unit that covers the nozzle openings and sucks the liquid from the nozzle openings;
a suction control unit that causes the sucking unit to suck the liquid from the nozzle openings; and
a liquid flow control unit that brings the pressure generating units into vibrations selectively corresponding to the pressure generating chambers to vibrate when sucking the liquid by the sucking unit and controls a flow of fluid in the pressure generating chambers by not driving the pressure generating units corresponding to the non-selected pressure generating chambers.

2. The liquid ejecting apparatus according to claim 1, wherein the vibrations that the liquid flow control unit causes the selected pressure generating unit to perform is micro vibrations.

3. The liquid ejecting apparatus according to claim 1, further comprising a detecting unit that detects a liquid filling state in the pressure generating chambers,
wherein the liquid flow control unit brings the pressure generating unit corresponding to the pressure generating chambers normally filled with the liquid into vibrations on the basis of the result of detection of the detecting unit.

4. The liquid ejecting apparatus according to claim 1, wherein the sucking unit includes a cap member that covers the nozzle openings and a sucking device that is connected to the cap member and sucks the interior of the cap member.

5. The liquid ejecting apparatus according to claim 1, wherein the liquid flow control unit applies vibration pulses having high frequencies in comparison with discharge driving pulses for discharging liquid to the pressure generating unit to cause vibrations.

6. A method of cleaning a liquid ejecting head that performs a sucking action for sucking liquid from a plurality of nozzle openings of the liquid ejecting head having the plurality of nozzle openings that ejects liquid, pressure generating chambers in communication with the respective nozzle openings; and a pressure generating unit that causes a pressure change in the pressure generating chambers, comprising: controlling a flow of the liquid in the pressure generating chambers by selectively bringing the pressure generating units corresponding to the pressure generating chambers into vibrations and sucking the liquid from the nozzle openings without bringing the pressure generating units corresponding to the non-selected pressure generating chambers into vibrations.
